(19) United States
(12) Patent Application Publication
(10) Pub. No.: US 2026/0031069 A1
(43) Pub. Date: Jan. 29, 2026

(54) SELF-LEVELING PAD ASSEMBLY FOR WOODWIND INSTRUMENTS AND METHOD OF USE

(71) Applicant: Dorian Corporation d/b/a MusicMedic.com, Wilmington, NC (US)

(72) Inventor: Curt Altarac, Wilmington, NC (US)

(73) Assignee: Dorian Corporation d/b/a MusicMedic.com, Wilmington, NC (US)

(21) Appl. No.: 18/998,955

(22) PCT Filed: Jul. 27, 2023
(86) PCT No.: PCT/US2023/028851

§ 371 Date: Jan. 27, 2025

Related U.S. Application Data
(60) Provisional application No. 63/392,933, filed on Jul. 28, 2022.

(51) Int. Cl. G10D 9/047; G10D 7/08

(52) U.S. Cl. CPC G10D 9/047; G10D 7/08

(57) ABSTRACT

Herein described are structures and assemblies used to level tone hole pads in woodwind instruments and methods of using the same. The structures and assemblies are self-leveling and include a gimbal support structure, a socket member, and a tone hole pad. The gimbal support structure attaches to a tone hole cover or cap and comprises a ball, stem and base. The socket member engages a housing positioned within the tone hole pad and the ball engages the socket member. Methods are provided for installation and use of the structures and assemblies.

### CROSS REFERENCE TO RELATED APPLICATIONS

This application is a § 371 national phase application of international application PCT/US2023/028851 filed Jul. 27, 2023 which claims priority to U.S. Provisional Application 63/393,933 filed Jul. 28, 2022, both applications incorporated by reference as if fully set forth herein.

### TECHNICAL FIELD

Structures and assemblies for leveling tone hole pads in woodwind instruments and methods of using the same.

### BACKGROUND

The traditional saxophone contains structures that protrude from the body and/or bell with a chimney or smokestack-like appearance. These structures, called “tone holes,” are strategically placed along the body to achieve a variety of notes and the best intonation possible. The player operates a variety of buttons, levers, and other structures, which together make up the instrument's keys, to close pads onto the surface of the tone hole to create a seal (like a gasket) and change the note being played. Each key is mounted on a hinge which is assisted by a spring to either be held open or held closed in a resting position. Due to the constraint of the player having far fewer fingers than tone holes to operate, there are many mechanisms and levers assisting with the opening and closing of the pads with a multitude of actions and points of activation. This leads to variation in pad pressure and proper tone hole sealing. Another variation comes from the fact that the back of the pad is closer to the fulcrum and the front of the pad is further from the fulcrum, and thus it has less leverage. An additional factor comes from the players themselves, who will operate the keys and levers with varying degrees of force, leading to uneven pressure located at the point where their finger or the lever pushes the pad down. The pressure on the pad rarely comes from the direct center causing conventional pads to rotate on an axis and create uneven pressure on the tone holes.

Conventional saxophone pads contain a cardboard backing, a felt center, and a piece of leather that wraps around the felt and is glued onto the cardboard backing. Medium and large size pads contain a resonator, which is made from plastic or metal in various shapes that rest on a portion of the surface of the pad to reflect sound waves back into the body of the saxophone. The resonator is held onto the pad with a rivet that passes through the center of the pad and crimped against the cardboard backing. Conventional pads are affixed in some manner to the inside surface of a pad cup, which is typically made of metal, most commonly brass. In operation, the soft leather pad surface contacts the tone hole creating a gasket-like seal.

Manufacturers have used different thicknesses of pads since the creation of the saxophone, and thus pad cup depth varies per manufacturer. To make up for this difference in some models, the installer will use thicker pads or shims behind the pads to raise the pad up in the pad cup. Traditionally, the variability in pad cup thickness necessitates expensive and unnecessary inventories of pads with varying thicknesses/sizes.

Conventional pads are affixed to the inside surface of the pad cup by welding or adhesives, such as shellac or hot melt glue through a process referred to as “padding.” Traditionally, the method for leveling a pad in relation to the tone hole in order to create the proper seal when in a closed position is a tedious and labor-intensive process. Depending on the desired precision, the process can take days to complete. The metal pad cup is heated until the adhesive inside of it softens and/or liquifies at which time the technician uses specialized tools to orient the pad in the cup until it is even and flat against the tone hole. Once the desire orientation is achieved, the technician holds the pad in place while the adhesive solidifies. As briefly mentioned, padding is time intensive and requires specialized tools and technical experience. Needless to say, an uneven pad seat is an indication that the pad was installed improperly. Leaking pads prevent the saxophone from performing optimally, cause decreased response, or sometimes prevent response altogether. Pads are very commonly replaced as they wear or harden due to being crushed over time, having an uneven seat, becoming sticky, or other factors.

### SUMMARY

Herein described is an apparatus, assemblies and/or structures used to level pads for tone holes (“tone hole pads”) in woodwind instruments, particularly saxophones. The assemblies described herein are self-leveling when properly installed within pad cups eliminating or substantially reducing application of uneven pad pressure on tone holes. Moreover, the self-leveling pad assemblies render “padding” as a part of the installation process obsolete, as well as the use of hot melt adhesives to affix the pad to the pad cup interior surface.

In one embodiment, the self-leveling pad assembly comprises a gimbal support member. In some embodiments, the gimbal support member includes a base, a knob or ball, and a stem positioned therebetween and connecting the base and knob. In further embodiments, the base can be secured to the interior metal surface of a pad cup. Balls and stems may be different sizes and lengths to accommodate varying pad cup thickness thereby eliminating the need for expensive and extensive tone hole pad inventories. The gimbal support member, in one embodiment, can be manufactured independently of the tone hole pad and secured to the interior metal surface prior to attachment to the pad.

In another embodiment, the self-leveling pad assembly comprises a socket member that receives the ball of the gimbal support member. In some embodiments, the socket member rests within a housing centrally positioned in the tone hole pad. On one side, the socket member may contain a centrally positioned socket column with an aperture or opening that receives and secures the ball of the gimbal support member. The socket column can include one or more relief cuts. In some embodiments, a trench surrounds the socket column. In one embodiment, the socket member contains two relief cuts on opposite sides of the socket column. In another embodiment, the interior surfaces of the tone hole pad housing and, at least a portion of the outer or exterior surface of the socket member, are polygonal shaped and complementary, such that the socket member fits securely in the housing when the angles and segments are aligned. In yet another embodiment, the housing and the at least a portion of the socket member are hexagonal and complementary. In some embodiments, the polygonal shaped socket member exterior surface is generally positioned on the same horizontal plane as the socket column and the trench surrounding the socket column. In some embodiments, the thickness of the polygonal shaped socket member exterior surface is approximately the same as the length of the socket column and the depth of the trench surrounding the socket column. In another embodiment, the polygonal shaped socket member exterior surface and the complementary polygonal shaped tone hole pad housing comprises a locking element (or anti-rotational element) configured to prevent rotation of said socket member when positioned within said housing.

In some embodiments, the socket member can include a protrusion extending in a direction opposite the socket column i.e., on the opposite side of the tone hole pad for securing a resonator. In one embodiment, the protrusion is attached to a platform positioned between (and on a different horizontal plane as-either above, below, to the left or right depending on orientation of said socket member) said protrusion and said polygonal shaped socket column exterior surface. In one embodiment, the platform is cylindrical shaped. In another embodiment, the cylindrical platform's outer circumference is slightly larger than the circumference of the polygonal shaped portion of the socket column exterior surface (e.g., assuming an invisible line connecting the angle vertices of a pentagram or hexagram and forming a circle). In one embodiment, the platform comprises a snap fastener due to the slightly larger outer circumference discussed above. In some embodiments, the platform/snap fastener deforms as it passes through the polygonal housing in the tone hole pad during installation and snaps back into shape when it clears the polygonal housing preventing reverse movement of the socket member.

In another embodiment, the self-leveling pad assembly includes a locking assembly. In some embodiments, the locking assembly includes one or more pins extending from the ball surface of the gimbal support member which engages the one or more relief cuts in the socket column. When the pin engages an interior stop surface within the in the relief cut, it prevents unwanted rotation of the ball within the socket thereby also the pad. In some embodiments, a pin is positioned in the socket member and the ball is slotted to engage the pin.

In another embodiment, a self-leveling tone hole pad assembly comprises:
a tone hole pad;
a gimbal support member;
a socket member;
wherein said gimbal support member comprises a base, a stem, and a ball; and
wherein said socket member comprises a socket column positioned on a first side of said socket member comprising a hollow interior and a column wall which defines the socket column, an opening to the hollow interior configured to receive said ball, and at least one relief cut through said column wall.

In some embodiments, the tone hole pad comprises a housing configured to securely receive said socket member.

In one embodiment, the housing comprises at least two adjacent flat sides and at least one angle between said at least two flat sides.

In one embodiment, the housing comprises a polygonal shape.

In yet another embodiment, the housing is hexagon shaped.

In one embodiment, the socket member further comprises a pin extending from a second side of said socket member opposite the first side, wherein said pin is configured to engage and secure a resonator to the self-leveling pad assembly.

In another embodiment, the pin comprises a terminal portion and an opening within said terminal portion.

In one embodiment, said socket member further comprises a cylindrically shaped platform from which said pin extends.

In another embodiment, said socket member further comprises a locking element comprising: an outer wall and an inner wall; and wherein said outer wall comprises at least two adjacent flat surfaces and at least one angle therebetween which complement the adjacent flat sides and angle of the housing.

In yet another embodiment, the socket member further comprises a trench positioned between the socket column wall and the inner wall of said locking element.

In another embodiment, said ball comprises a locking pin extending from its surface configured to engage said at least one relief cut in said column wall and prevent rotation of said ball within said socket column.

A method of installing a self-leveling tone hole pad assembly comprising the steps of:

providing a self-leveling tone hole pad assembly comprising a tone hole pad; a gimbal support member; a socket member; wherein said gimbal support member comprises a base, a stem, and a ball; and wherein said socket member comprises a socket column positioned on a first side of said socket member comprising a hollow interior and a column wall which defines the socket column, an opening to the hollow interior configured to receive said ball, and at least one relief cut through said column wall;

snapping said socket member into the tone hole pad;

inserting said ball into said socket column to secure said gimbal support member to said socket member;

dispensing a predetermined volume of cyanoacrylate onto the base of said gimbal support member;

contacting said cyanoacrylate containing base to an interior surface of a pad cup; and
manipulating the planar positioning of said tone hole pad to test its self-leveling function.

The method described above, further comprising the step of securing a resonator to said socket member.

The method described above further comprising dispensing a predetermined volume of cyanoacrylate to the surface of said socket member prior to snapping the socket member into the tone hole pad.

A method of installing a self-leveling of a tone hole pad assembly comprising the steps of:
providing a self-leveling tone hole pad assembly comprising a tone hole pad; a gimbal support member; a socket member; wherein said gimbal support member comprises a base, a stem, and a ball; wherein said socket member comprises a socket column positioned on a first side of said socket member comprising a hollow interior and a column wall which defines the socket column, an opening to the hollow interior configured to receive said ball, and at least one relief cut through said column wall; and wherein said ball comprises a locking pin extending from its surface configured to engage said at least one relief cut in said column wall and prevent rotation of said ball within said socket column;
turning the gimbal support member within the socket column until said pin engages the relief cuts.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a side view of an embodiment of the gimbal support member and socket member with resonator securing protrusion visible.

FIG. 2 shows a more elevated view of the gimbal support member and socket member as shown in FIG. 1.

FIG. 3 shows a tone hole pad hexagonal housing with a socket member and a gimbal support member positioned next to the pad.

FIG. 4A shows a tone hole pad with socket member placed in housing and aperture visible.

FIG. 4B shows an elevated perspective of a socket member with both aperture and protrusion visible.

FIG. 5 shows a tone hole pad with socket member placed in housing and protrusion visible.

FIG. 6 shows a tone hole pad with gimbal support member engaged to socket member.

FIG. 7 shows a tone hole pad with resonator secured by socket member protrusion.

FIG. 8 shows an embodiment of a socket member and aperture.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The terms “a,” “an,” and “the,” as used herein, generally refers to singular

and plural references unless the context clearly dictates otherwise.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Similarly, the use of these terms in the specification does not by itself connote any required priority, precedence, or order.

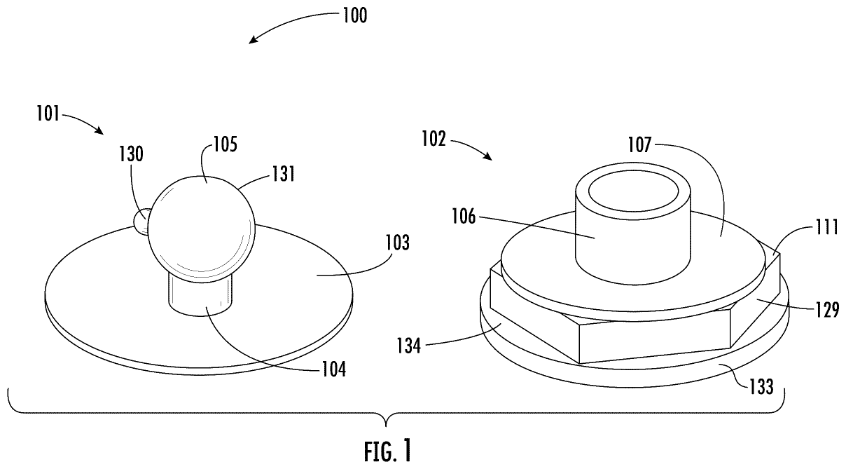

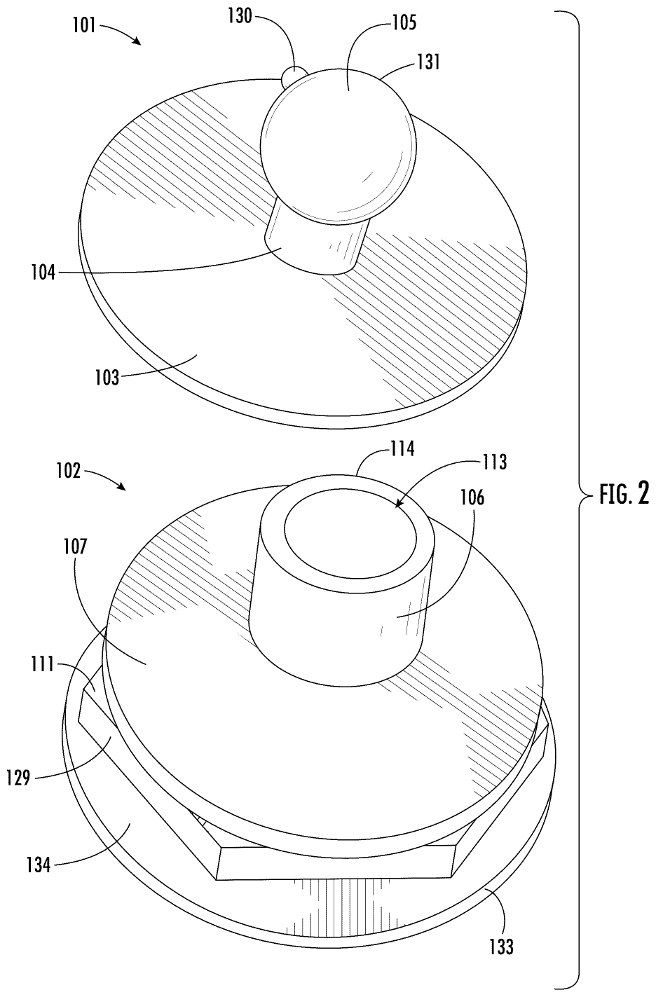

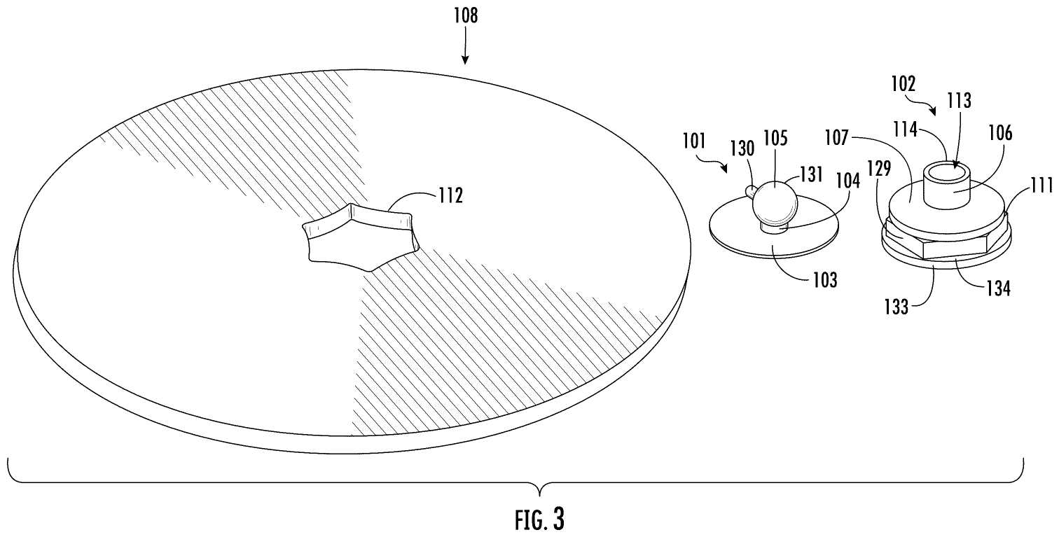

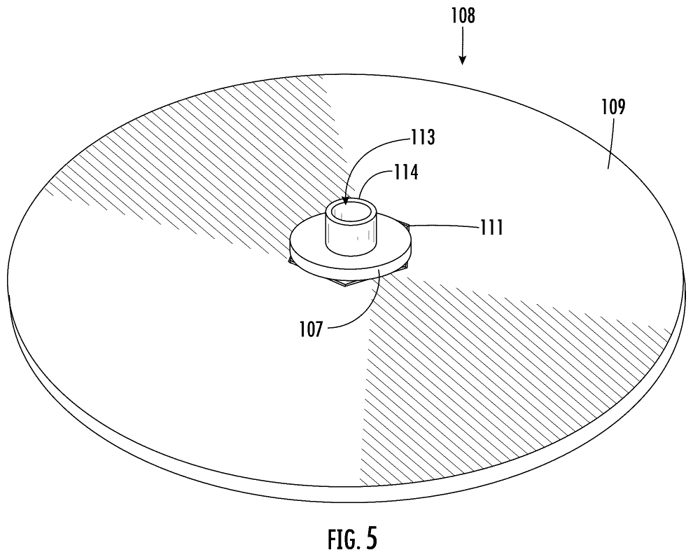

Referring to FIG. 1, an embodiment of two primary structural components of the self-leveling pad assembly 100 are shown-the gimbal support member 101 and the socket member 102. As shown in the embodiment, gimbal support member 101 includes a flat base 103, a stem 104, and a knob or ball 105. Referring to socket member 102, a protrusion 106 for engaging and securing a resonator (described in greater detail below) is prominently shown in FIG. 1. The socket member 102 further contains a cylindrically shaped platform 107 from which the protrusion 106 extends, resembling a chimney stack in this embodiment. As shown in FIG. 5, when socket member 102 is properly positioned within the tone hole pad 108, both the protrusion 106 and the platform 107 extend above the substantially flat or slightly contoured first (e.g., front) surface 109 of the tone hole pad 108. Referring again to FIG. 1, also shown is a polygonal shaped locking element 111 positioned below (in this illustration) the platform 107 which, together with a complementing shaped housing 112 (see FIGS. 5 and 3), prevents rotation of the socket member 102 when inserted into the housing 112. In the embodiment illustrated in the figures, the housing and locking element are hexagonal; however, other designs (e.g., shapes) may be equally suitable. In some embodiments, an adhesive (e.g., sealing wax, micro cement, hot glue, cyanoacrylate adhesives) may be added to strengthen the joint or interface between the locking element 111 and housing 112. In some embodiments, protrusion 106 can have an aperture or opening 113 at its end or terminus 114, as shown in FIG. 5.

In some embodiments, the outer circumference of said platform 107 can be slightly larger than the housing 112 generating a fastening element. In one embodiment, during installation, as said platform 107 is pushed through said housing 112, platform 107 deforms in order to pass through the housing 112. When the platform 107 passes through and completely clears the housing 112, the platform shape rebounds to its original/resting circumference. Due to its slightly larger circumference, the socket member cannot be backed out or reversed and pushed back through the housing absent the application of significant force. The combined interaction between the housing 112 and platform 107 produces the fastening element (i.e., 112 and 107) in this embodiment.

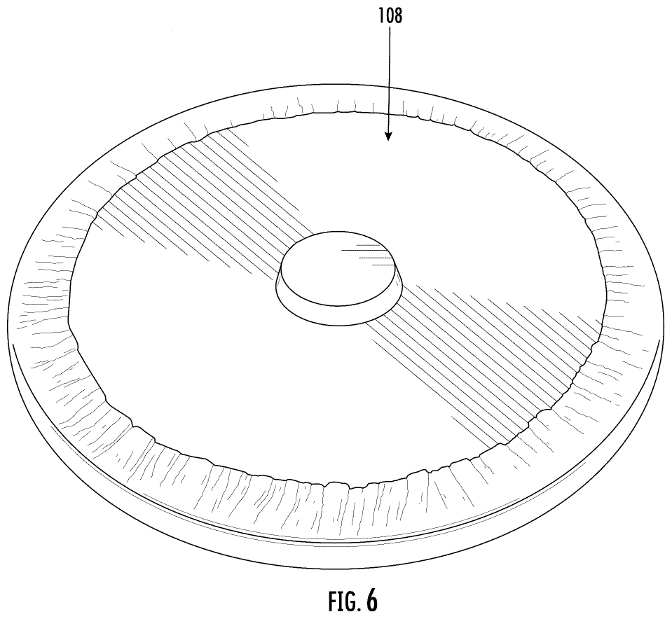

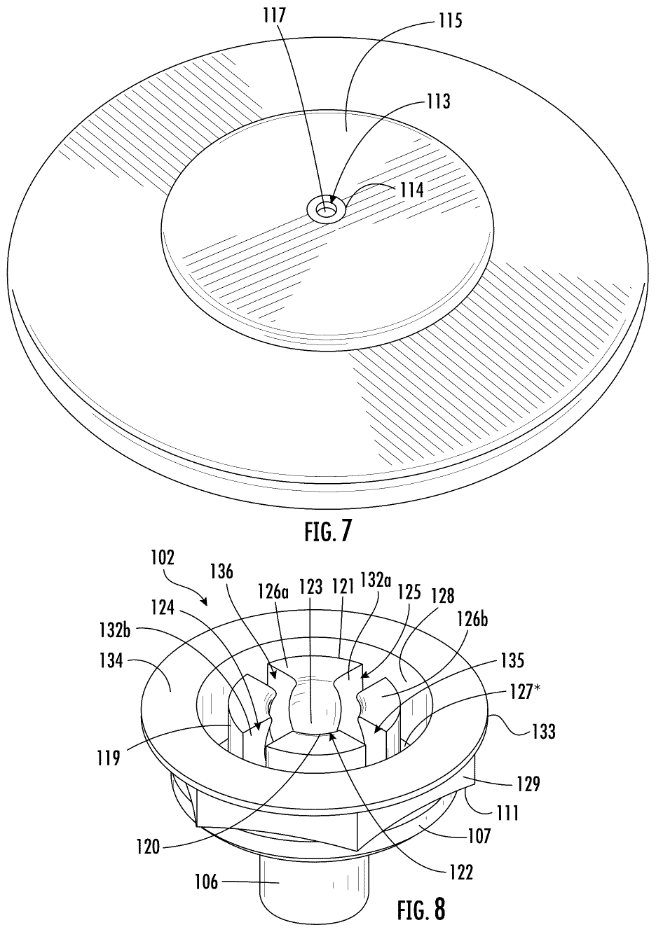

FIG. 7 shows a fully assembled self-leveling pad assembly with a covered (with suitable material) tone hole pad first (e.g., front) surface. FIG. 6 shows the back side of the self-leveling pad assembly of FIG. 7. As shown in FIG. 7, in one embodiment, the protrusion 106 is inserted into resonator 115, such that resonator 115 is secured flush against the tone hole pad surface. In the embodiment depicted in FIG. 7, protrusion 106 is inserted into an resonator housing 117 (similarly sized to the protrusion for snug fit) within the resonator 115. When properly inserted, such that resonator is secured to the self-leveling pad assembly, protrusion terminus 114 is flush to the resonator's outer surface (i.e., it does not extend beyond the surface) or, alternatively, the terminus 114 is just beneath the resonator's outer surface (in other words, slightly less than flush to the outer surface) forming a pit, hole or depression. In some embodiments, resonator housing 117 does not extend all the way through the resonator 115, or alternatively, the housing 117 is covered, such that protrusion 106 is not visible following insertion into resonator housing 115. protrusion 106 may not be visible if In some embodiments, protrusion 106 is between 1 and 10 mm in length. In other embodiments, the protrusion 106 is between 2 and 5 mm in length. In yet another embodiment, the protrusion 106 is 3 mm in length.

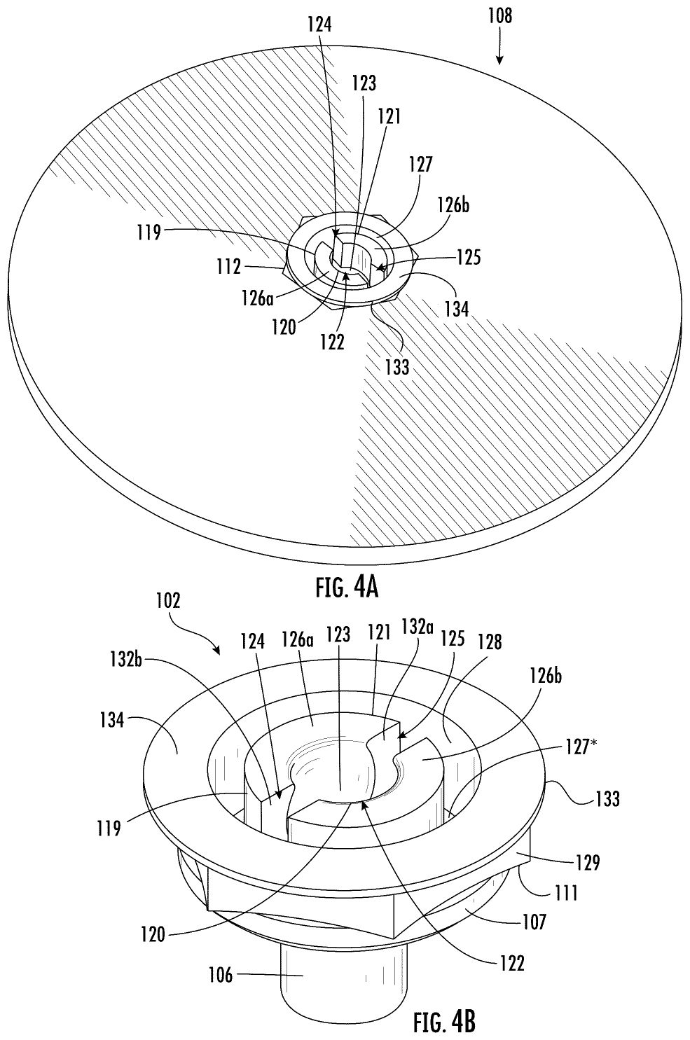

Referring now to FIGS. 4A-B depicting the socket member side opposite the protrusion 106, the socket member 102 embodiment illustrated in FIGS. 4A-B includes a socket column 119 with an inner surface 120 and an outer surface 121, a socket aperture 122 and socket shaft 123 defined by said inner surface 120. In this embodiment, socket column 119 includes a first relief cut 124 and a second relief cut 125 directly opposite the first relief cut, such that said socket column is divided into two crescent-shaped column walls 126a and 126b. With reference to FIG. 4B, socket member further includes a trench 127 circumferentially surrounding the outer surface 121 of the socket column 119 and defined by an inner wall 128 of locking element 111 and said outer surface 121 of the socket column. As is shown, locking element 111 contains an inner (circular shaped) wall 128 and an outer (polygonal shaped) wall 129, which engages said pad housing 112 (snaps into position) to prevent rotation of the socket member within said pad housing. In the embodiment shown in FIGS. 4A-B, the socket member 102 includes a base 133 with a flange 134, illustrated as positioned above the inner wall 128 and outer wall 129, includes a flange 134 extending over pad housing 112 outer edges and engaging the surface of the tone hole pad 108. FIG. 4A illustrates the opposite side of the tone hole pad 108 from FIG. 5 and depicts a substantially flat or slightly contoured second surface 137 (e.g., back surface) of the tone hole pad 108.

With continuing reference to FIG. 4B, the importance of the socket member elements, particularly the relief cuts 124, 125 and the trench 127 to the self-leveling pad assembly's versatility should be noted. For example, the relief cuts offer a range of tolerances for ball 105 size variation, while maintaining the friction force needed to secure said variably sized balls 105. The trench 127 accommodates or creates space for socket column shape changes caused by variably sized balls 105 and/or forces applied by said ball 105 on the socket column 119 as a musician (or other instrument operator) presses the key, which helps achieve the self-leveling function.

Gimbal support member 101 and socket member 102 can be manufactured separately out of materials including plastics, thermoplastics, polymers, copolymers, and/or blends of polyolefin, polyamide, and/or polyvinyl compounds. In one embodiment, the material used to manufacture these components is polyethylene, polypropylene or blend thereof. In another embodiment, the materials are selected from those suitable for 3D printing including, but not limited to acrylonitrile butadiene styrene, polylactic acid, polyethylene terephthalate, nylon, thermoplastic polyurethane, polyvinyl alcohol, and polystyrene. In yet another embodiment, gimbal support member 101 and socket member 102 can be made of a metallic substance, such as brass or steel. Alternatively, gimbal support member 101 and socket member 102 may be manufactured together via single mold.

In some embodiments, the ball 105 of gimbal support member 101 can include one or more locking pins or protrusions 130 on its surface 131 as shown in FIG. 1. The locking pin 130 engages said first or second relief cuts 124 and 125 via stop surfaces 132a-b, as illustrated in FIG. 4 preventing unwanted rotation of the socket column 119 on the ball 105 and, thus also, the tone hole pad. The embodiment illustrated in FIG. 8 depicts four relief cuts 124, 125, 135, and 136 and four stop surfaces 132a-d. In some embodiments, the ball 105 can include two or more pins or protrusions 130 for engaging more than one or a plurality of relief cut. In alternative embodiments, the structures described above may be reversed i.e., said relief cuts can be positioned in the ball 105 and said pin 130 can be positioned in the socket member.

During operation of the invention, when the musician activates a key resulting in pad/tone hole engagement, the center mounted self-leveling pad receives pressure only from the center of the cup regardless of where the player pushes resulting in evenly distributed tone hole surface coverage and a consistent seal. The self-leveling function is undetectable to the musician during operation. The friction generated from the interaction between the socket column and ball (e.g., ball joint) promotes positional memory and stability, even after the pad is lifted up from the tone hole during normal play. The self-leveling pad moves from the position only when physically moved or due to lost or reduced friction from normal wear.

A method of assembling the self-leveling pad assembly, can comprise the following steps. The ball of the gimbal support member is inserted into the socket column of the socket member and held in place via friction between the socket column and ball. The locking element of the socket member is snapped into the pad housing and, in some embodiments, adhesive (e.g., cyanoacrylate) may be applied to this joint, for example, on the pad material. In some embodiments, a resonator is placed upon the protrusion and secured thereto; however, for small pads, the self-leveling assembly may not include a protrusion as small pads do not require resonators. A small volume of cyanoacrylate is placed on the gimbal support member's base surface (that secures to the pad cup interior surface) and while curing (approximately 3 seconds), the pad is tilted in all directions. Alternatively, the gimbal support member can be affixed to the pad cup interior surface prior to insertion of the ball into the socket column. Pads are replaced by disengaging the socket member of the old pad from the gimbal support member and installing a new pad containing a new socket member onto the ball of the gimbal support member. It should be noted that the self-leveling pad assembly described herein substantially reduces time it takes to level the pad via traditional methods (i.e., padding).

Gimbal support members can be made with varying ball 105 (and/or stem 104) sizes (e.g., three sizes) to accommodate different pad cup sizes i.e., thickness, and to give the pad the appearance and feel of a thick pad when necessary and/or allow the pad clearance to tilt inside the pad cup. In some embodiments, the thickness of the base 103 likewise can be modified to change the height. This eliminates the traditional need to maintain a large supply of pads with different thicknesses. The complete self-leveling pad assembly can also come in variable sizes to accommodate small (e.g., 17.5 mm diameter and under), medium and large pads. In one embodiment, the assembly comes in two sizes, one which accommodates medium and large size pads, and one which accommodates smaller pads.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, relative proportions and process/method step sequences set forth herein which depend upon a variety of conditions and variables. It should be understood that various alternatives to the embodiments of the invention, including for example, method step sequence described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A self-leveling tone hole pad assembly comprising:
a tone hole pad;
a gimbal support member;
a socket member;
wherein said gimbal support member comprises a base, a stem, and a ball; and
wherein said socket member comprises a socket column positioned on a first side of said socket member comprising a hollow interior and a column wall which defines the socket column, an opening to the hollow interior configured to receive said ball, and at least one relief cut through said column wall.

2. The self-leveling tone hole pad assembly of claim 1, wherein said tone hole pad comprises a housing configured to securely receive said socket member.

3. The self-leveling tone hole pad assembly of claim 2, wherein said housing comprises at least two adjacent flat sides and at least one angle between said at least two flat sides.

4. The self-leveling tone hole pad assembly of claim 3, wherein said housing comprises a polygonal shape.

5. The self-leveling tone hole pad assembly of claim 4, wherein said polygonal shape is a hexagram.

6. The self-leveling tone hole pad assembly of claim 1, wherein said socket member further comprises a pin extending from a second side of said socket member opposite the first side, wherein said pin is configured to engage and secure a resonator to the self-leveling pad assembly.

7. The self-leveling tone hole pad assembly of claim 6, wherein said pin comprises a terminal portion and an opening within said terminal portion.

8. The self-leveling tone hole pad assembly of claim 7, wherein said socket member further comprises a cylindrically shaped platform from which said pin extends.

9. The self-leveling tone hole pad assembly of claim 3, wherein said socket member further comprises a locking element comprising:
an outer wall and an inner wall;
and wherein said outer wall comprises at least two adjacent flat surfaces and at least one angle therebetween which complement the adjacent flat sides and angle of the housing.

10. The self-leveling tone hole pad assembly of claim 9, wherein said socket member further comprises a trench positioned between the socket column wall and the inner wall of said locking element.

11. The self-leveling tone hole pad assembly of claim 1, wherein said ball comprises a locking protrusion extending from its surface configured to engage said at least one relief cut in said column wall and prevent rotation of said ball within said socket column.

12. The self-leveling tone hole pad assembly of claim 1 wherein said ball comprises a plurality of locking protrusions extending from its surface configured to engage a plurality of relief cuts in said column wall to prevent rotation of said ball within said socket column. 13. The self-leveling tone hole pad assembly of claim 9, wherein said socket member further comprises a base comprising a flange configured to engage a first surface of said tone hole pad.

14. A method of installing a self-leveling tone hole pad assembly comprising the steps of:
providing a self-leveling tone hole pad assembly comprising a tone hole pad; a gimbal support member; a socket member; wherein said gimbal support member comprises a base, a stem, and a ball; and wherein said socket member comprises a socket column positioned on a first side of said socket member comprising a hollow interior and a column wall which defines the socket column, an opening to the hollow interior configured to receive said ball, and at least one relief cut through said column wall;;
snapping said socket member into the tone hole pad;
inserting said ball into said socket column to secure said gimbal support member to said socket member;
dispensing a predetermined volume of adhesive onto the base of said gimbal support member;
contacting said adhesive containing base to an interior surface of a pad cup; and
manipulating the planar positioning of said tone hole pad to test its self-leveling function.

15. The method of claim 14, wherein said adhesive is cyanoacrylate adhesive.

16. The method of claim 14, further comprising the step of securing a resonator to said socket member.

17. The method of claim 14, further comprising dispensing a predetermined volume of adhesive to the surface of said socket member prior to snapping the socket member into the tone hole pad.

18. The method of claim 14, wherein said adhesive is cyanoacrylate adhesive.

19. The method of claim 14, wherein said ball comprises a locking protrusion extending from its surface configured to engage said at least one relief cut in said column wall and prevent rotation of said ball within said socket column and further comprising the step of turning the gimbal support member within the socket column until said locking protrusion engages said at least one relief cut.
